(19) United States
(12) Patent Application Publication
(10) Pub. No.: US 2010/0059188 A1
(43) Pub. Date: Mar. 11, 2010

(54) MEANS FOR TEMPORARY CLOSING OF AN OPENING

(76) Inventor: Joseph Abramovitch, Bat Yam (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 11/915,332

(22) PCT Filed: May 31, 2005
(86) PCT No.: PCT/IL2005/000561

§ 371 Date: Nov. 18, 2009

(51) Int. Cl. E06B 9/00

(52) U.S. Cl. 160/368.1

(57) ABSTRACT

Means for closing an opening in a wall consisting of a plastic cloth and a flexible air duct having the length of the opening perimeter and having a nipple inserted into one end with the second end being deadly closed. The opening is closed by a plastic cloth with its ends covering butt ends of the opening and an air duct being laid over the cloth along the whole perimeter of the opening, the said air duct being spread inside the opening after air pumping into it, and thus holding the cloth in its place like a frame.

### TECHNICAL FIELD

The present invention relates to the field of civil engineering and is destined for protecting workers from rain, snow and cold winds when working in buildings/structures where windows haven't been installed yet.

### BACKGROUND ART

According to civil engineering technology all the interior works (floor covering, partitions erection, sanitary works, etc.) are carried out at the time when there are no windows in window openings.

Temporary closure of window openings is carried out for that period to protect workers from unfavorable atmospheric conditions (precipitations and winds).

Construction according to U.S. Pat. No. 5,345,989 dated 13 Sep. 1994, US Cl. 160/354, 160/368.1; Int.Cl. A47H 023/00 seems to be the closest one out of the known solutions having legal protection.

This invention providing for temporary closure of wall opening is based on the fact that, first, a frame of unjustifiably complex structure is installed on opening butt-ends (frame fixing elements holding the frame in the opening are positioned on the inner as well as on the outer side of the opening) and only then a protective film is stretched on the outer side.

According to another, more recent invention (U.S. Pat. No. 6,179,037 dated 30 Jan. 2001, US Cl. 160/3681; Int.Cl.E06B 003/00) screen retention system is provided for installing screen covers over large openings having polygonal frames comprising a plurality of mounting strips attached to a frame, each mounting strip having a plurality of posts. Each post has a substantial girth and has an enlarged head formed as its tip, the underside of the head forming a catch substantially around the entire underside. Screen material is mounted over the posts and the heads retain the screen thereon and therefore resist large lateral forces exerted by tension in the screen. A closure loop strip entangles the post heads to retain the loop strip thereon.

However, both solutions mentioned are characterized by great complexity of the structures (constructions) themselves and their mounting.

It seems to be this reason that, before starting autumn-winter period (or rain period), wooden frames are being made more often than all the other structures, then covered with transparent plastic film and afterwards inserted all together into window openings at building sites.

The structures described are destined only for one time application, and with installation of stationary windows or with improvement in weather conditions (sunny days) these frames are simply thrown away.

A number of negative moments accompanying such solution (workers engagement for making frames, wood wasting and the most depressive thing—necessity in preparing the same structures for the next year) serves as the basis for developing the proposed structure of a temporary window free of the drawbacks inherent to known solutions and, thus, constituting the aim of the present invention.

### DISCLOSURE OF INVENTION

The aim set forth is attained due to the proposed means for temporary closing of an opening in a flat structure dividing the space, in particular in a wall of a building or a structure under construction; this means is made in the form of a temporary window positioned in a window opening (before installing stationary windows) and comprising two main elements: a transparent plastic cloth and a frame holding this cloth in a window opening.

It is proposed to use a flexible and thin air duct, in particular a tubular one, with its length corresponding to the perimeter of a window opening.

One end of such an air duct is deadly closed, and the other end is fitted with a nipple.

This means that if such an air duct is laid inside a window opening along all its four sides: sideward along butt-ends of the walls, upward along the window lintel and downward along the window sill, then the air duct in such a state will acquire the form of a frame.

In case the window opening is closed with plastic cloth and its ends are positioned between the air duct and window opening sides, then, with air being pumped into, the air duct (further called an air-frame) expanding due to inner pressure retains the edges of a plastic cloth against the sides of the window opening.

Thus, window opening is closed by a plastic cloth with its edges being retained against the butt-ends of the window opening by an air-frame and the pressure inside the air-frame is held by a nipple during all the period of temporary window functioning.

In this case it is necessary to prevent the internally pressurized air-frame from running off the window perimeter line and its possible ejection from the window opening.

To prevent ejecting, the material for air-frame manufacture should meet the following requirements:
it should be strong enough to withstand the necessary pressure when pumping in;
it should be flexible and elastic to be retained against the whole relief of the window opening which is far from being smooth (droplets of mortar, concrete, chipped parts, unfilled seams, etc.);
it should be soft enough to become slightly spread and flattened as a strip along the perimeter of the window opening when pumping in. This will increase the area of the air-frame touching the plastic cloth and, correspondingly, the butt-ends of the window opening. Thus, air-frame stability inside the window opening is increased;
the air-frame outer surface should be ribbed like car wheel protector. This increases air-frame grip with window opening butt-ends, thus increasing air-frame stability inside the window opening.

Lines in the form of a rectangle corresponding to the definite window opening perimeter are applied to the plastic cloth.

Then semi-rings are secured to the cloth at definite intervals (i.e. in series) along the perimeter lines; inner diameter of the semi-rings corresponding to the outer diameter of the air-frame.

Air frame is passed through these semi-rings (further called way-frames) in the same way as belt is passed through loops in the pants, thus preserving the air-frame fixed position along the perimeter line. It also increases air-frame stability inside the window opening.

As the structure of the temporary window is absolutely simple, its manufacture can be carried out at plants as well as at the building site.

### BRIEF DESCRIPTION OF THE DRAWINGS

The essence of the invention is explained by the drawings attached where:

FIG. 1 shows a part of a window opening closed by a temporary window.

FIG. 2 shows an air-frame prepared for a corresponding plastic cloth.

FIG. 3 shows a plastic cloth with way-frames attached to it.

FIG. 4 illustrates the abilities of using a standard plastic cloth in window openings of different sizes (variants in FIGS. 4A, 4B, 4C, 4D).

FIG. 5 illustrates the abilities in using a temporary window under conditions of a building under construction (droplets of mortar, concrete, popping up structures, etc.).

FIG. 6 shows a separate way-frame.

FIG. 7 shows a set of way-frames connected into a belt and rolled up.

FIG. 8 illustrates the operation of gluing separate way-frames along the line of window opening perimeter (FIGS. 8A, 8B, 8C, etc.).

FIG. 9 shows parts and elements out of which the air-frame can be assembled at the building site (FIG. 9A shows a nipple, FIGS. 9B and 9E—different ends of the air duct, FIGS. 9C and 9D show elements providing for tight connection of a nipple with an air duct).

FIG. 10 illustrates an air-frame securing to a plastic cloth by means of a masking tape.

FIG. 11 shows a part of a window opening closed by a temporary window with double running of an air-frame (reinforced variant for regions with increased wind loading).

### BEST MODE FOR CARRYING OUT THE INVENTION

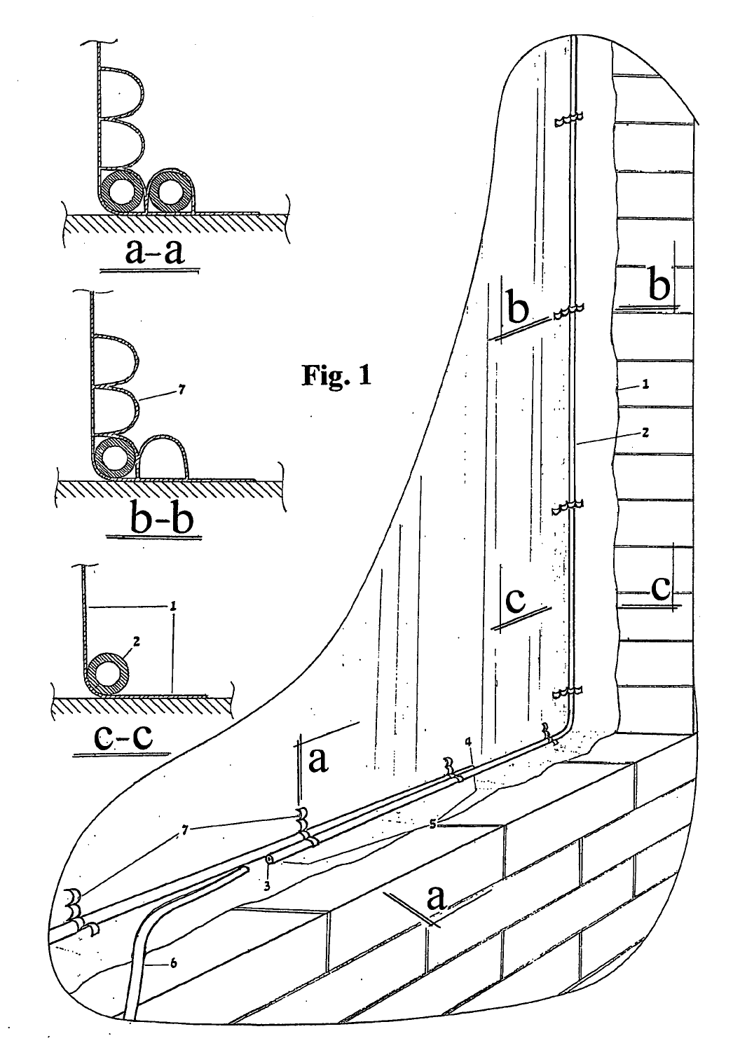

The means proposed in the form of a temporary window installed in a window opening is given in FIG. 1 representing the chosen (best variant).

Plastic cloth 1 closing a window opening has air-frame 2 running along its edges and bending around all the sides of the window opening.

As one of the ends 3 of air-frame 2 is fitted with a nipple for pumping air in, it seems to be more convenient to carry out pumping in when end 3 is lying on a window sill.

The other end 4 of air-frame 2 made as a dead end must close the perimeter of the window opening and meet end 3, but, for better stability of air-frame 2 in the window opening, it is better to elongate end 4 for distance 5 along running air-frame 2.

Taking into account the presence of such a double-way part 5, air-frame 2 length is initially taken longer than the perimeter of the given air frame.

It is expedient to carry out air pumping in by means of a foot-driven pump installed on the floor and connected by an air duct to end 3.

Choice of a foot-driven pump is stipulated by two factors: rather small volume of air to be pumped into an air-frame (it is enough to press the pump pedal several times to pump the air in) and, what is more important, both hands of an operator remain free, thus facilitating temporary window installing.

In case when a temporary window is completely manufactured at a plant, a definite order (number of windows, their sizes, terms of delivery, etc.) is sent from the building site.

According to that order, a plastic cloth is marked with the necessary perimeter, an air-frame of the necessary length is run round it and then fixed to the cloth by means of way-frames—a temporary window is ready.

Installation of a temporary window in its most acceptable variant (i.e. with minimum labor expenditures) is carried out in case the temporary window itself has been preliminary manufactured at a plant and arrives ready-made to the building site.

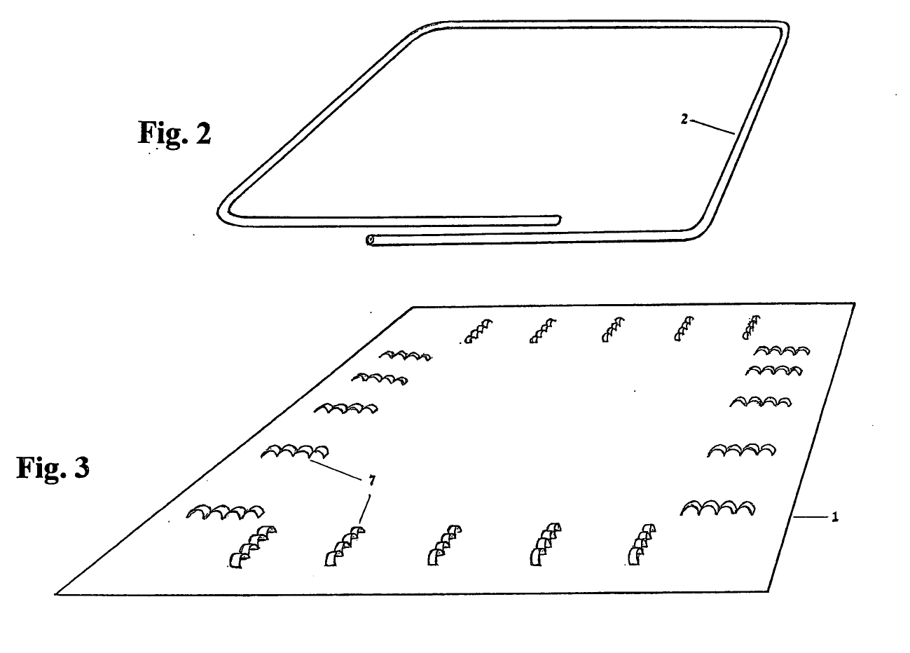

In this case the length of air-frame 2 (FIG. 2) is taken with necessary reserve taking into account double-way part 5 (FIG. 1) as well as a possible application of the existing air-frame to a plastic cloth of a larger size in the process of exploitation.

In case, due to some reasons, a plastic cloth is to be manufactured on site, a roll of plastic cloth should exist at the building site and a rectangle according to the size of a definite window opening is to be cut out of it. Way-frames can be manufactured at a plant, and in this case they are simply glued to a plastic cloth.

And, finally, in case a temporary window is to be completely manufactured at the building site, then, besides a plastic cloth roll and a set of way-frames, a coil of rolled air-ducts and a set of nipples is necessary.

An air-duct of necessary length is cut from the coil, its one end being deadly closed, and the second being fitted with a nipple an air-frame is ready.

Plastic cloth 1 (FIG. 3) is manufactured separately and way-frames 7 are secured along its perimeter.

Way-frames 7 represent separate groups of semi-rings connected to each other and positioned along the cloth at definite intervals. General view of a plastic cloth resembles a stadium with roads prepared for hurdling.

Such positioning of way-frames 7 (FIG. 3) makes plastic cloth a universal material for application in window openings of different sizes.

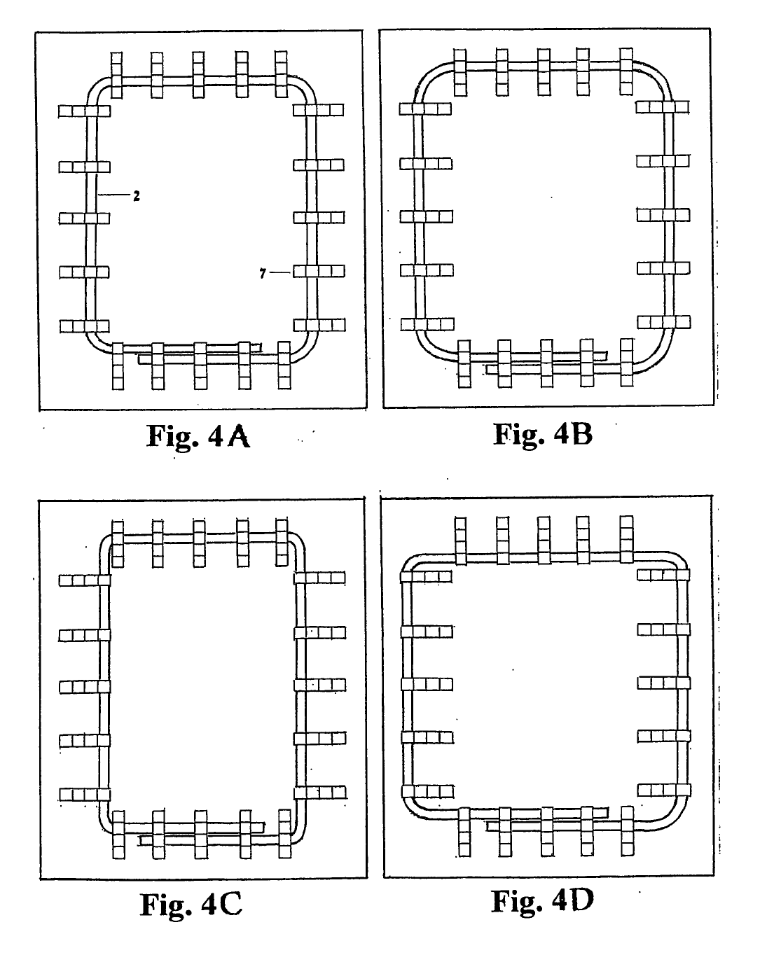

Thus, for example, in case it is necessary to prepare a temporary window for definite window openings (order with corresponding sizes is coming from the building site), then air-frame 2 is led through the way-frame 7 perimeter (FIG. 4A) which corresponds to the order obtained.

In case the order for a larger size of window opening is given, then air-frame 2 is led through other way-frames 7 (FIG. 4B).

Leading air-frames along corresponding way-frames it is possible to manufacture a narrow temporary window (FIG. 4C—for lavatories, shower-rooms, bathrooms) or wide and low ones (FIG. 4D—for garage, workshops, service rooms, etc.).

But the main advantage of plastic cloth shown in FIG. 3 becomes clear at the building site when it is necessary to change the old plastic cloth which came out of order.

As it is known from engineering practice, plastic cloth will be damaged rather often, and, thus, plastic cloth storage at the building site should be bigger than that of air-frames.

In case of changing a torn plastic cloth (FIG. 3), air-frame is taken out of it, led through the same way-frames on the new plastic cloth which correspond to a definite window opening perimeter.

The process of installing a temporary window represents a step by step running of an air-frame along the inner sides of a window opening with additional simultaneous pumping the air in.

After first pumpings in, an air-frame starts keeping closer to inner sides of a window opening but still remains rather flexible and soft.

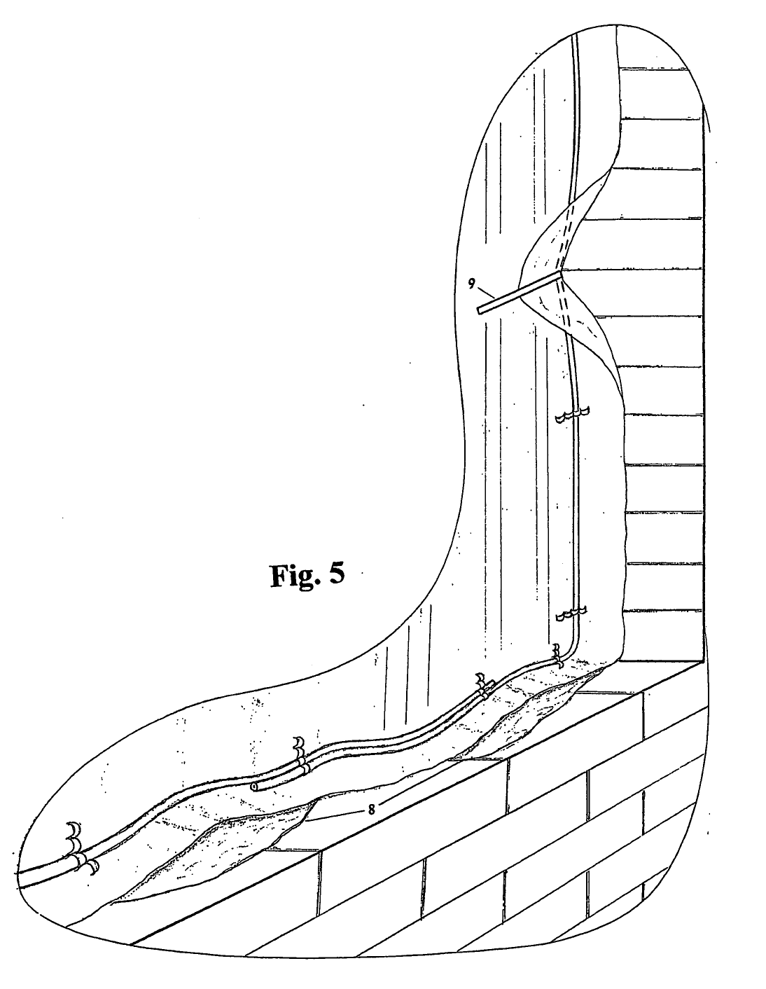

This will permit an operator to slightly displace the air-frame if necessary determining its most stable position corresponding to real conditions of construction—droplets of mortar, concrete bosses 8 (FIG. 5), popping out fittings 9, etc.

This way of air-frame installing should be accompanied by additional periodic pumping air in, securing the air-frame in necessary points.

After the air-frame having taken its most stable position inside the window opening, the operator makes some final pumpings, thus finally securing a temporary window inside a window opening.

Out of two components of a temporary window—an air-frame and a plastic cloth—the latter will be going out of order more often than the former.

In case of the absence of a plastic cloth (as air-frames) manufactured at a plant, plastic cloth of corresponding sizes can be easily fabricated at the building site.

As the plastic cloth itself can be easily cut from the roll according to the sizes of a window opening, the only thing that remains is fastening way-frames to it.

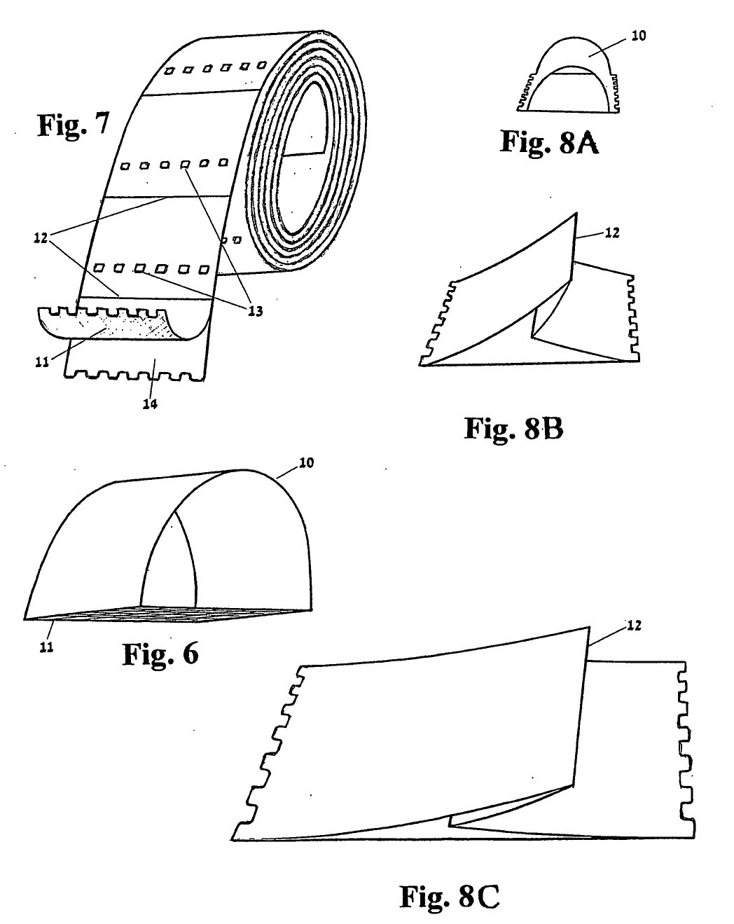

A way-frame (FIG. 6) consists, in particular, of half-cylinder (semi-ring) 10 and bottom 11.

Air-frame is led through half-cylinder 10, and bottom 11 is glued to the plastic cloth.

When way-frames are manufactured industrially, they are produced connected to each other by their side surfaces approximately in the way shown in FIG. 3, but only in the form of a belt.

For rolling such a belt into a coil (FIG. 7) each half-cylinder 10 is folded in pleats having several surfaces so that in a folded flat state only pleat 12 is seen on the top.

For easier separation of one way-frame from the other, their connection lines are perforated with alternating orifices 13.

For gluing a separate way-frame to a plastic cloth, glue is spread on cloth bottom 11; the bottom having been closed by easily removed film 14 up to the moment of gluing (analogous to envelopes at the post office).

Perimeter line of a definite window opening is preliminary applied to the plastic cloth and then separate (at that time flat) way-frames are torn from the roll (FIG. 7) and glued to the plastic cloth at definite intervals (FIGS. 8A, 8B, 8C).

When it is necessary to pass air-frames through way-frames, glued up way-frames are unfolded and again transformed from flat pleats into half-cylinders 10 (FIGS. 8C, 8B, 8A).

At part 5 of the perimeter where double-way running of air-frame is proposed (FIG. 1) not one but two connected way-frames should be torn off the roll (FIG. 7) and then glued together to the plastic cloth.

In case of necessity not only a plastic cloth but air-frame can be prepared at the building site.

To do that such components as air-ducts 2 (FIG. 1) rolled in a coil, a definite number of nipples as well as auxiliary attachments of the type masking tape, cable tier, etc. should be available at the building site.

For air-frame fabrication necessary length of air duct is cut off from the coil, its one end being fitted with a nipple and the second one being deadly closed.

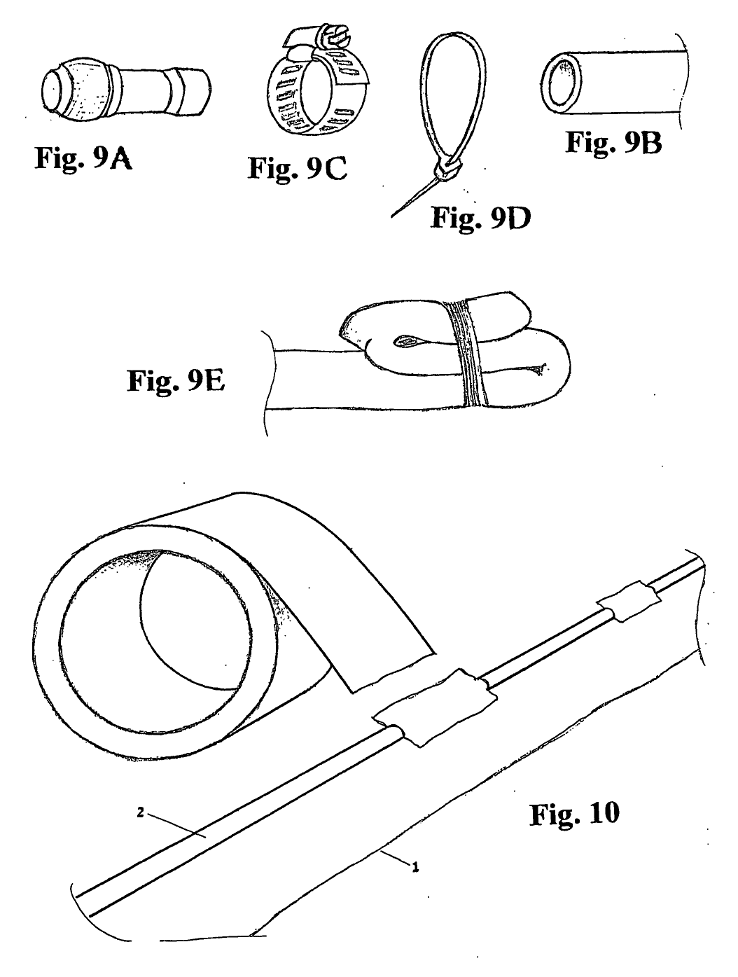

A nipple (FIG. 9A) is inserted into one of the ends of the air-frame (FIG. 9B) after that this connection is tight enough to prevent air leakage under pressure. It can be made using such attachments as cable tier (FIG. 9D) or band bracer (FIG. 9C).

The other end of air-frame can be closed or bent is such a way as shown in FIG. 9E.

Plastic cloth is cut off the roll according to dimensions of the window opening.

Way-frame can be glued ready-made (FIG. 8A) or, in case of its absence, air-frame can be glued along the perimeter line to the plastic cloth by a masking tape (FIG. 10).

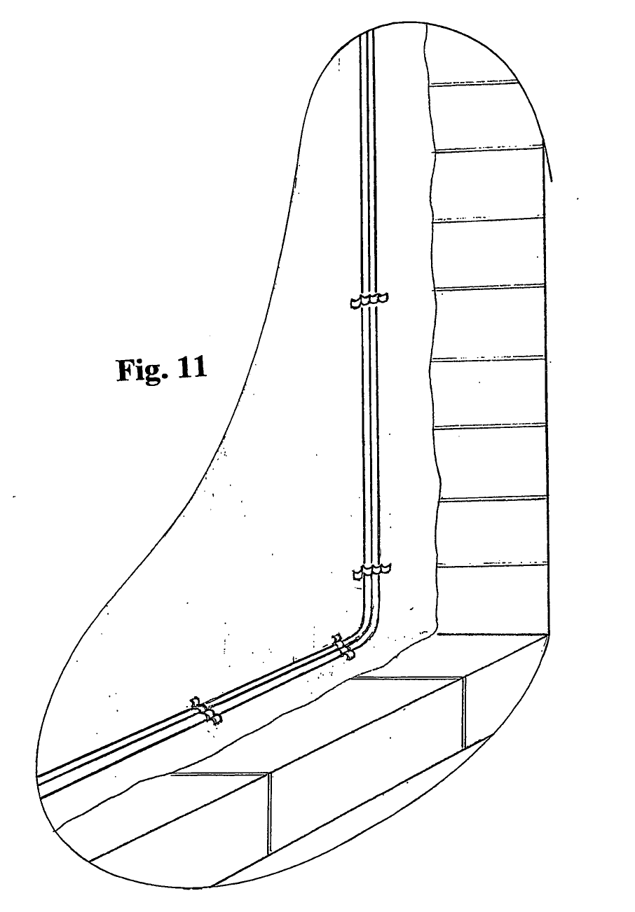

In the regions where very strong winds are blowing, i.e. where a threat of temporary window being torn out of the window opening by wind gust exists, air-frame should be taken of a double length and it should run round the window opening perimeter twice (FIG. 11).

### INDUSTRIAL APPLICABILITY

Industrial applicability of the invention proposed is substantiated by such its qualities as:
Simplicity of structure consisting of a plastic cloth and air-frame.
Speedy and simple installing in a window opening without any special training.
Ability of multiple application at different building sites.
Saving in labor and wood necessary for making wooden frames.
Flexibility and elasticity of air-frame permitting to use it in real conditions of construction (droplets of mortar and concrete, popping out fittings) as well as with original architectural solutions (window openings having round, oval, rhombic shape, etc).
Possibility for speedy changing of torn off plastic cloth for a new one using still applicable air-frame.
Possibility of complete or partial quick fabrication of a temporary window at the building site.
Possibility of using temporary window design during construction and renovation.
Possibility of using temporary window in regions with increased wind load.

Taking into account all the above said, we are sure to state the possibility of even wider application of the proposed invention for temporary closing openings, holes, breaks etc. in any flat structure dividing the space (wall, partition, bulkhead, etc.) with necessity of transparency (passing light) through a closed opening in the structure mentioned.

1. A means for temporary closing of an opening in a flat structure dividing the space, in particular in a wall of a building/structure under construction made in the form of a temporary window positioned in a window opening before installing a stationary window consisting of:
a transparent plastic cloth for closing the window opening,
fitted with loops positioned in series in the perimeter zone of the cloth and secured to the cloth, these loops being made, e.g., in the form of semi-rings,
through which in a stationary functional position of the cloth, a flexible pumped air duct is led,
bending round a window opening along its perimeter and having the length equal, at least, to the perimeter of the opening,
hereby one of the air duct ends being deadly closed and the second one fitted with a nipple through which air is pumped into the air duct expanding the air duct inside the window opening,
transforming the air duct into a frame retaining a plastic cloth inside the window opening.

2. The means, according to claim 1,
wherein flexible air duct is made, at least, of a double length and positioned inside the window opening with corresponding, in particular, double running round it, providing necessary strength for fixing the frame formed by the air duct, in particular, in region with increased wind load.
